(19) United States
(12) Patent Application Publication
(10) Pub. No.: US 2004/0112795 A1
(43) Pub. Date: Jun. 17, 2004

(54) Method for sulphurizing hydrotreating catalysts

(76) Inventors: Claude Brun, Idron (FR); Georges Fremy, Sauvetterre de Bearn (FR)

Correspondence Address: Thomas F Roland, Atofina Chemicals Inc, Patent Department 26th Floor, 2000 Market Street, Philadelphia, PA, 19103-3222, US

(21) Appl. No.: 10/468,936

(22) PCT Filed: Feb. 13, 2002
(86) PCT No.: PCT/FR02/00548

(30) Foreign Application Priority Data
Feb. 22, 2001 (FR) 01/02410

(51) Int. Cl. C10G 45/02; B01J 27/02; B01J 27/047; B01J 27/051; B01J 27/049

(52) U.S. Cl. 208/213; 502/216; 502/219; 502/220; 502/221; 502/222; 208/216 R; 208/217

(57) ABSTRACT

The invention concerns a method for sulphurizing catalysts for hydrotreating of hydrocarbon feedstocks. The invention is characterised in that it consists in sulphurizing the catalyst in two steps: the first step consisting in sulphurization with tertiary mercaptan in the absence of hydrogen, and the second step, carried out consecutively in the same reactor, consisting of sulphurization with another sulphurizing agent in the presence of hydrogen. The catalysts thus sulphurized prove to be more active than those sulphurized by only the second step.

The present invention relates to the field of the hydrotreating of hydrocarbonaceous feedstocks and has more particularly as subject-matter a process for the sulphidation of the catalysts used for this purpose.

The catalysts for the hydrotreating of hydrocarbonaceous feedstocks to which the present invention relates are used under conditions appropriate for converting organosulphur compounds to hydrogen sulphide in the presence of hydrogen, which operation is known as hydrodesulphurization (HDS), and for converting organonitrogen compounds to ammonia in an operation which is known as hydrodenitrogenation (HDN).

These catalysts are generally based on metals from groups VIB and VIII of the Periodic Classification of the Elements, such as molybdenum, tungsten, nickel and cobalt. The most commonly used hydrotreating catalysts are formulated from cobalt-molybdenum (Co—Mo), nickel-molybdenum (Ni—Mo) and nickel-tungsten (Ni—W) systems deposited on porous inorganic supports, such as aluminas, silicas or silicas/aluminas. These catalysts, manufactured industrially in very large tonnages, are supplied to the user in their oxide forms (for example, cobalt oxide-molybdenum oxide catalysts on alumina, symbolized by the abbreviation: Co—Mo/alumina).

However, these catalysts are active in hydrotreating operations only in the form of metal sulphides. This is why, before being used, they have to be sulphided.

As regards the activation of hydrotreating catalysts, the sulphidation of these catalysts is an important stage in obtaining their maximum performance with regard to HDS and HDN. As is indicated by the authors of Hydrotreating Catalysis (Catalysis, Vol. 11, 1996, p. 25, edited by J. R. Anderson and M. Boudart), practical experience has shown that the sulphidation procedure can have a significant influence on the activity and stability of the catalyst, and much effort has been devoted to improving the sulphidation procedures.

The most direct method for the sulphidation of a catalyst consists in treating the latter with hydrogen sulphide mixed with hydrogen. However, this method, which has formed the subject-matter of many patents (U.S. Pat. Nos. 3,016,347, 3,140,994, GB 1,309,457, U.S. Pat. Nos. 3,732,155, 4,098,682, 4,132,632, 4,172,027, 4,176,087, 4,334,982, FR 2,476,118), has major disadvantages (acute toxicity, availability of H₂S) which do not allow it to be employed on every industrial site.

The industrial procedures for the sulphidation of the catalysts are generally carried out under hydrogen pressure with liquid feedstocks already comprising sulphur compounds as sulphiding agents. The method chiefly used in the past by refiners consisted in sulphiding the catalysts with the sulphur-comprising oil feedstocks, but this technique had significant disadvantages because of the difficulty of converting the sulphur compounds to hydrogen sulphide. To avoid the reduction of the catalysts by the hydrogen, the sulphidations, initiated at low temperature, had to be taken slowly to high temperature in order to obtain complete sulphidation of the catalysts.

Sulphur-comprising additives have been proposed for improving the sulphidation of the catalysts. The method consists in incorporating a sulphur compound (spiking agent) in a feedstock, such as a naphtha, or in a specific fraction, such as a VGO (vacuum gas oil) or an LGO (light gas oil). U.S. Pat. No. 3,140,994 was the first to claim the use of compounds of different natures which are liquid at ambient temperature: carbon disulphide, thiophene, mercaptans, dialkyl disulphides and diaryl disulphides. Organic sulphides, in particular dimethyl sulphide, have also formed the subject-matter of claims. Dimethyl disulphide (DMDS) has been more particularly recommended for the sulphidation of the catalysts and an effective method for sulphidation with dimethyl disulphide is disclosed in Patent EP 64,429.

H. Hallie (Oil and Gas Journal, Dec. 20, 1982, pp 69-74) has reviewed these procedures for sulphidation under hydrogen which are carried out directly in hydrotreating reactors. These various techniques for the sulphidation of catalysts, known as “in situ” techniques, have been compared and studies have shown that sulphidation with a liquid feedstock to which has been added a sulphiding agent which has the property of decomposing at low temperature (spiked feedstock) is the best sulphidation technique. The technique without an additional sulphiding agent (nonspiked feedstock) gives a less active sulphided catalyst. The sulphiding agent which it is preferred to add to the feedstock is dimethyl disulphide.

Organic polysulphides have also been claimed as sulphiding agents for the sulphidation of the catalysts. U.S. Pat. No. 4,725,569 discloses a method for the use of organic polysulphides of RSₓR′ type (it being possible for R and R′ to be identical or different, with x equal to or greater than 3) which consists in impregnating the catalyst at ambient temperature with a solution comprising the polysulphide, in subsequently removing the inert solvent and, finally, in carrying out the sulphidation, under hydrogen, of the charged catalyst in the hydrotreating reactor. In Patent EP 298,111, the polysulphide of RSₓR′ type, diluted in a liquid feedstock, is injected during the sulphidation of the catalyst in the presence of hydrogen.

Functionalized mercaptans, such as mercaptocarboxylic acids or esters, dithiols, aminomercaptans and hydroxy-mercaptans, as well as thiocarboxylic acids or esters, are claimed in Patent EP 289,211 for the sulphidation of the catalysts.

More recently, new techniques for the sulphidation of the catalysts comprising two stages have been developed. In a first stage, known as an “ex situ” stage, the catalyst is preactivated in the absence of hydrogen outside the refinery after having been impregnated with a sulphiding agent. The complete sulphidation of the catalyst is carried out in the hydrotreating reactor in the presence of hydrogen. The “ex situ” presulphidation relieves the refiner from injecting a sulphiding agent during the sulphidation of the catalyst under hydrogen. The “ex situ” techniques developed at present use organic polysulphides or sulphur as sulphur-comprising products.

An industrial technique for the presulphidation of catalysts under “ex situ” conditions, based on the use of organic polysulphides of the RSₓR′ type (it being possible for R and R′ to be identical or different and x≧3), has formed the subject-matter of Patent EP 130,850. This process consists in impregnating the catalyst, in oxide form, with a solution of organic polysulphides, such as tert-nonyl polysulphides (TPS 37 or TNPS, sold by Atofina), in a hydrocarbon of the white spirit type. This preliminary stage of incorporation of a sulphur compound of a specific nature in the catalyst is supplemented by a heat treatment of the catalyst in the absence of hydrogen at temperatures not exceeding 150° C. This operation has the effect of removing the organic solvent and of ensuring the attachment of the sulphur to the catalyst by means of the organic polysulphides. At this presulphidation stage, the catalyst is stable in air and can be handled without specific precautions. It is supplied in this state to the user who, after charging to the hydrotreating reactor, can bring the sulphidation of the catalyst to completion under hydrogen for the complete conversion of the metals to metal sulphides.

Other organic polysulphide compounds, with different structures, have also been claimed for the presulphidation of the catalysts under “ex situ” conditions. The products recommended in Patents FR 2,627,104 and EP 329,499 have the general formula: R′—(S_{y}—R—Sₓ—R—S_{y})—R′ and are obtained from olefins and sulphur chloride by a series of successive stages which involve a reaction with an organic monohalide, followed by a reaction with an alkaline polysulphide. In Patent EP 338,897, the products claimed are synthesized from olefins and sulphur chloride with an additional reaction with an alkaline mercaptide or an alkaline polysulphide mercaptate.

The development of a technique for the “ex situ” presulphidation of the catalysts using sulphur in suspension in an oil (U.S. Pat. No. 4,943,547) has presented such problems of industrial application that it has been necessary to develop a new process for sulphidation with sulphur which consists in bringing the catalyst into contact with sulphur and an olefin of high boiling point. The catalyst, thus impregnated, is subsequently heat-treated at a temperature of greater than 150° C. and then the sulphidation of the catalyst is brought to completion under hydrogen at temperatures of greater than 200° C.

Very recently, in Patent FR 2,758,478, it has been shown that the joint use of a tertiary mercaptan and another sulphidation agent, such as dimethyl disulphide, for example, makes it possible to obtain hydrotreating catalysts which are more active with regard to the hydrodesulphurization of hydrocarbonaceous feedstocks than catalysts sulphided in the absence of tertiary mercaptan. According to this patent, the tertiary mercaptan can be incorporated during an “in situ” sulphidation under a stream of hydrogen, before or during the introduction of the sulphidation agents generally used. For a person skilled in the art, an “in situ” sulphidation of the catalyst is always carried out under a stream of hydrogen. In this type of operation, the catalyst is introduced into the hydrotreating reactor in the oxide form and is sulphided in the presence of the sulphidation agent under a stream of hydrogen, in contrast to “ex situ” presulphidations, where the catalyst is presulphided outside the hydrotreating reactor.

The present invention now relates to a specific “in situ” embodiment of this tertiary mercaptan. This is because it has been found, surprisingly, that the “in situ” preintroduction of the tertiary mercaptan in the absence of hydrogen, followed by the consecutive introduction in the same reactor of the other sulphidation agent (for example dimethyl disulphide), this time in the presence of hydrogen, also makes it possible to obtain catalysts which are significantly more active than those sulphided with dimethyl disulphide alone.

A subject-matter of the invention is thus a process for the in situ sulphidation of a metal hydrotreating catalyst comprising a stage of treatment of the catalyst with a tertiary mercaptan in the absence of hydrogen, followed, in the same reactor, by a stage of treatment with another sulphidation agent in the presence of hydrogen.

The tertiary mercaptans relating to the present invention are the same as those mentioned in Patent FR 2 758 478 and correspond to the general formula:

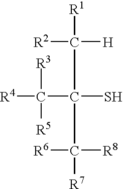

in which the R¹, R², R³, R⁴, R⁵, R⁶, R⁷ and R⁸ symbols, which are identical or different, each represent a hydrogen atom or a linear or branched alkyl radical, an aryl radical, an alkylaryl radical or an aralkyl radical, it being possible for these radicals to comprise one or more heteroatoms, such as oxygen and/or sulphur.

The preferred tertiary mercaptans of the invention are those which comprise from 4 to 16 carbon atoms. Such mercaptans are manufactured industrially from hydrogen sulphide and olefins by catalytic processes such as those disclosed in particular in U.S. Pat. No. 4 102 931, EP 101 356 and EP 329 521. tert-Butyl mercaptan (TBM) is thus manufactured from isobutene, tert-nonyl-mercaptan (TNM) is thus manufactured from tripropylene and tert-dodecyl mercaptan (TDM) is thus manufactured from tetrapropylene or triisobutylene. The most particularly preferred tertiary mercaptan is TDM.

The first stage of the process according to the invention (in situ treatment of the catalyst with a tertiary mercaptan in the absence of hydrogen) consists essentially in incorporating the tertiary mercaptan in the pores of the catalyst and in subjecting the catalyst thus impregnated to thermal activation under an atmosphere of an inert gas (for example, nitrogen or methane). The pure tertiary mercaptan can be used for the impregnation of the catalyst but it is advantageous to employ it in the form of a solution in an organic solvent (preferably an alkane or a desulphurized gas oil), it being possible for the concentration of tertiary mercaptan in this solution to vary within wide limits according to the nature of the tertiary mercaptan, its sulphur content and the pore volume of the catalyst to be sulphided.

The in situ impregnation of the catalyst by the tertiary mercaptan in the absence of hydrogen can be carried out according to 2 methods:

The first method, to saturation of the pore volume, consists in passing, over the catalyst, a volume of solution comprising the tertiary mercaptan and the organic solvent described above in the desired proportions. The volume of this solution corresponds to the total pore volume of the mass of catalyst. This volume is subsequently increased slightly to take into account the wetting volume of the inert material (SiC-carborundum) which is placed in front of the catalyst.

The second method, by recirculation, consists in circulating in a loop, over the catalyst, a volume of solution comprising the tertiary mercaptan and the organic solvent in the desired proportions. This volume of solution is greater than the total pore volume of the mass of catalyst. Analysis over time shows that the recycled solution becomes exhausted in tertiary mercaptan and that the latter is retained by the catalyst.

Thermal activation is carried out at a temperature which can range from 50 to 250° C. but is preferably between 100 and 175° C. The pressure is not a critical parameter for this operation and can range from atmospheric pressure up to 35 bar.

The sulphur compounds to be used as sulphidation agents in the second stage of the process according to the invention can be various in nature: feedstock to be desulphurized, carbon disulphide, light mercaptans (for example, ethyl mercaptan and n-butyl mercaptan), dimethyl sulphide, dimethyl disulphide (DMDS) and optionally polysulphides, such as di-tert-nonyl polysulphide or di-tert-butyl polysulphide; polysulphides obtained from sulphur and olefins can also be used. The most particularly preferred sulphidation agent is DMDS.

This sulphidation agent is generally introduced as a mixture with a gas oil, under a hydrogen pressure which can range from atmospheric pressure to 200 bar but is preferably between 10 and 50 bar, the pressure range commonly used industrially. This second stage of the process according to the invention (in situ treatment of the catalyst with the other sulfidation agent in the presence of hydrogen) is carried out at a temperature which can range up to 350° C.; a higher temperature would reduce the sulphidation time but would increase the risk of coking. It is advantageous to carry out this second stage in two steps:

a primary sulphidation carried out at a temperature of between 150 and 250° C., preferably between 210 and 230° C., so as to minimize the time necessary for the achievement of the breakthrough of H₂S into the outlet gases without risking a premature reduction, then

a secondary sulphidation carried out at a temperature of between 250 and 350° C., preferably between 290 and 330° C., and with a sufficient duration to have a constant concentration of H₂S in the outlet gases.

The hydrogen coverage, expressed by the ratio of the volume flow rate of hydrogen in standard litres to the volume flow rate of gas oil in litres can be between 50 and 500 Sl/l, preferably between 100 and 300 Sl/l.

The hourly space velocity (HSV), defined as the ratio of the hourly volume flow rate of gas oil to the volume of catalyst, can range from 0.1 to 5 h⁻¹ and is preferably between 1 and 3 h⁻¹, a range commonly used industrially.

The total amount of sulphur contributed by the tertiary mercaptan and the other sulphidation agent can range from 100 to 250% of the weight of sulphur stoichiometrically required for the complete conversion to sulphides of the oxides of the catalyst. The proportion of tertiary mercaptan used in the implementation of the process according to the invention can represent from 1 to 100% of the weight of total sulphur necessary for the sulphidation of the catalyst. The sulphur contributed by the tertiary mercaptan has a particularly appreciable effect from 10% by weight of the total sulphur necessary for the sulphidation of the catalyst.

The present invention will be better understood with the help of the experimental part which follows by way of illustration. The aim of Examples 1 and 2 presented is to show the increases in catalytic activity which can be obtained in a test hydrotreating reaction, the hydrodesulphurization (HDS) of thiophene, with an industrial Co—Mo/alumina catalyst which has been subjected to an in situ sulphidation under conventional sulphidation conditions (Example 1) and to an in situ sulphidation under conditions specific to the present invention (Example 2). The aim of Examples 3 and 4 is to illustrate the in situ impregnation of the catalyst by the tertiary mercaptan according to the recirculation method.

### REFERENCE EXAMPLE 1

### Sulphidation with Dimethyl Disulphide

The catalyst used is a commercial hydrodesulphurization catalyst (KF756 from Akzo) composed of cobalt and molybdenum oxides supported on alumina and exhibiting the following characteristics:

shape: quadrilobal

diameter: 1.3 mm

density: 760 g/l

pore volume: 0.6 ml/g

stoichiometric sulphur for sulphiding 100 g of catalyst: 11 g

Procedure for Sulphidation with DMDS:

The sulphidation was carried out in a reactor (internal volume: 120 ml) placed in an oven with three heating regions and equipped at its outlet with a device which makes it possible to separate the liquid phase and the gas phase and to recycle them. A sampler makes it possible to collect liquids in order to determine therefrom the level of total sulphur present in the gas oil and to subsequently carry out analyses by gas chromatography.

30 g of catalyst (i.e. approximately 40 ml) were introduced into the reactor between two layers of carborundum (SiC), an inert agent which promotes wetting of the catalyst and which also acts as thermal buffer. After drying under nitrogen at 150° C., the catalyst was wetted with a gas oil resulting from the atmospheric distillation of a crude oil (Straight Run Gas Oil; hereinafter SRGO) and exhibiting the characteristics collated in the following table:

TABLE 1

| Type of feedstock | | SRGO |
|---|---|---|
| Density, 15° C. | g/cm³ | 0.8741 |
| Nitrogen | ppm | 239 |
| Sulphur | % wgt | 1.1 |
| ASTM D86x* | | |
| S.P. | ° C. | 227.3 |
| 5% vol. | ° C. | 274.5 |
| 10% vol. | ° C. | 292.0 |
| 30% vol. | ° C. | 315.5 |
| 50% vol. | ° C. | 332.0 |
| 70% vol. | ° C. | 348.0 |
| 90% vol. | ° C. | 367.0 |
| 95% vol. | ° C. | 373.0 |
| F.P. | ° C. | 373.7 |

*ASTM D86: Standard for distillation of petroleum fractions

After having placed the reactor under hydrogen pressure, the DMDS was injected so as to add 1.5% of sulphur to the SRGO. The sulphidation with DMDS was carried out under the following conditions:

H₂ pressure=35 bar

H₂/SRGO=250 Sl/l

Hourly space velocity HSV=2 h⁻¹

After a primary sulphidation with a stationary phase at 220° C. maintained until the achievement of an H₂S breakthrough of at least 3 000 ppmV, a sulphidation was carried out at high temperature (320° C.), which temperature is maintained as long as there is fixing of sulphur.

The catalyst was subsequently recovered, washed and dried and then a portion of the catalyst was milled under argon to produce particles with a size of 0.2 to 0.5 mm, which particles were mixed with SiC for the purpose of the test of activity.

Test of Activity (HDS of Thiophene):

The hydrodesulphurization reaction of thiophene was carried out at atmospheric pressure according to the following procedure:

The temperature of the reactor is maintained at 400° C., while an H₂S/H₂ mixture with an H₂S content of 2% by volume is introduced into the reactor at a gas flow rate adjusted to 5.4 l/h. Before mixing with the H₂S, the hydrogen is conveyed to a saturator comprising liquid thiophene thermostatically controlled at a temperature such that the partial pressure of the thiophene in the gas entering the reactor is 60 torr (8 kPa).

These reaction conditions make it possible to measure low levels of conversion of the thiophene.

The gaseous effluents exiting from the reactor are analysed by chromatography to determine the unconverted thiophene and the C₄ hydrocarbons formed.

The reaction is monitored for 3 hours with periodic analyses of the gaseous effluents.

Evaluation of the activity of the catalyst with regard to HDS of thiophene

The degree of conversion of the thiophene is calculated from the chromatographic analyses of the reaction effluents.

The evaluation of the activity of the catalyst for the hydrodesulphurization test reaction is determined by the rate of disappearance of the thiophene under these conditions.

For the KF756 Co—Mo/alumina catalyst presulphided with dimethyl disulphide according to the conditions described in this Example 1, a rate of conversion of the thiophene (k_{ref}) of 5.39 kg per hour and per litre of catalyst is obtained in this reference test.

To facilitate the comparison of the results of catalytic activity of the various tests which were carried out to demonstrate the increases in rate of conversion of the thiophene obtained in the context of the present invention, a relative activity, expressed as RVA (Relative Volumic Activity), with a value equal to 100 was assigned to this reference test.

### EXAMPLE 2

### According to the Invention

40 ml (30 g) of KF756 catalyst were introduced into the reactor and then impregnated with 21.7 g of a 15% by mass solution of tert-dodecyl mercaptan (TDM) in hexane at ambient temperature. The impregnated catalyst was subsequently dried under nitrogen at a pressure of 7 bar and a temperature of 150° C.

The dry catalyst was subsequently subjected to a sulphidation with DMDS identical to that described in Example 1 and then the activity of the catalyst thus sulphided with respect to HDS of thiophene was tested as in Example 1.

In this test, a rate of conversion of the thiophene (k) of 6.77 kg per hour and per litre of catalyst was obtained with the sulphided catalyst according to the invention, i.e. an RVA, expressed by the relationship:

RVA=100×k/k_{ref}

of 126.

TABLE 2
Results

| | EXAMPLE | |
|---|---|---|
| | 1 | 2 |
| Sulphidation procedure | DMDS/H₂ | 1: TDM/N₂ |
| | | 2: DMDS/H₂ |
| RVA at 400° C. | 100 | 126 |

A very significant increase in hydrodesulphurizing activity is thus obtained when the sulphidation procedure relating to the invention (Example 2) is used in comparison with a conventional sulphidation method (Example 1).

### EXAMPLE 3

40 ml (30 g) of KF756 catalyst were introduced into the reactor and 138.6 g of a mixture composed of 19.4 g of TDM and 119.2 g of desulphurized gas oil were introduced over 30 minutes into the liquid recycle loop. At a starting temperature of 50° C., the solution is recirculated under up flow conditions with respect to the catalytic bed with a flow rate of 80 cm³/h, under a stream of nitrogen of 20 l/h at a pressure of 4 bar and with a temperature rise of 50° C./h up to a stationary phase temperature of 150° C.

After a stationary phase of 8 h at 150° C., i.e. 10 h after the introduction of the solution, analysis of the liquid recycle shows that 83% of the TDM initially present has reacted with the catalyst.

### EXAMPLE 4

40 ml (30 g) of KF756 catalyst were introduced into the reactor and 138.6 g of a mixture composed of 19.4 g of TDM and 119.8 g of desulphurized gas oil were introduced over 30 minutes into the liquid recycle loop.

At a starting temperature of 50° C., the solution is recirculated under up flow conditions with respect to the catalytic bed with a flow rate of 80 cm³ /h, under a stream of nitrogen of 20 l/h at a pressure of 4 bar and with a temperature rise of 50 C./h up to a stationary phase temperature of 120° C. The stationary phase of 120° C. is maintained for 1/5 h and then, with a rise of 50° C./h, a second stationary phase of 135° C. is reached, which is maintained for 2 h. Subsequently, the third stationary phase of 150° C. is reached with a rise of 50° C./h.

After a stationary phase of 1 h at 150° C., i.e. approximately 6 h after the end of the introduction of the solution, analysis of the liquid recycle shows that 92% of the TDM initially present has reacted with the catalyst.

1. Process for the in situ sulphidation of a metal hydrotreating catalyst comprising a stage of treatment of the catalyst with a tertiary mercaptan in the absence of hydrogen, followed, in the same reactor, by a stage of treatment with another sulphidation agent in the presence of hydrogen.

2. Process according to claim 1, in which the metal catalyst to be sulphided is a mixture of cobalt and molybdenum oxides, a mixture of nickel and molybdenum oxides or a mixture of nickel and tungsten oxides or any other combination of these oxides, this mixture of oxides being supported by an alumina, a silica or a silica/alumina.

3. Process according to claim 1 or 2, in which the tertiary mercaptan is tert-dodecyl mercaptan.

4. Process according to one of claims 1 to 3, in which the other sulphidation agent is dimethyl disulphide.

5. Process according to one of claims 1 to 4, in which the first stage comprises an impregnation of the catalyst with the tertiary mercaptan and then a thermal activation under an inert atmosphere.

6. Process according to claim 5, in which the thermal activation is carried out at a temperature of between 100 and 175° C.

7. Process according to one of claims 1 to 6, in which the second stage is carried out in two steps, first at a temperature of between 150 and 250° C., until breakthrough of H₂S into the outlet gases is obtained, and then at a temperature of between 250 and 350° C., until a constant concentration of H₂S in the outlet gases is obtained.

8. Process according to one of claims 1 to 7, in which the total amount of sulphur contributed by the tertiary mercaptan and the other sulphidation agent ranges from 100 to 250% of the weight of sulphur stoichiometrically required for the complete conversion to sulphides of the oxides of the catalyst.

9. Process according to claim 8, in which the proportion of tertiary mercaptan corresponds to more than 10% by weight of the total sulphur necessary for the sulphidation of the catalyst.

10. Use of a metal catalyst sulphided by a process according to one of claims 1 to 9 for the hydrotreating of hydrocarbonaceous feedstocks.
